(19) United States
(12) Patent Application Publication
(10) Pub. No.: US 2008/0120670 A1
(43) Pub. Date: May 22, 2008

(54) SYSTEM AND METHOD FOR TRACKING CONSUMER ACTIVITIES WITHIN A DIGITAL MAGAZINE

(76) Inventors: Robert Easton, Newport Beach, CA (US); Michael Galley, West Linn, OR (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/932,539

(22) Filed: Oct. 31, 2007

Related U.S. Application Data
(60) Provisional application No. 60/855,534, filed on Oct. 31, 2006.

(51) Int. Cl. H04N 7/173

(52) U.S. Cl. 725/115

(57) ABSTRACT

The present disclosure provides a system and method for tracking usage of a digital magazine and using that and other information to customize the digital magazine experience. A customizable digital magazine server, according to the disclosure, includes a recipient database that stores records on a digital magazine's recipients. The server utilizes information stored in the database to provide a digital magazine customized based on the recipient's information. The digital magazine also contains a module that monitors the recipient's interactions with the digital magazine and reports the interactions back to the recipient database.

### PRIORITY CLAIM

This application claims priority to U.S. Provisional Application No. 60/855,534, titled “System and Method for Tracking Consumer Activities within a Digital Magazine” and filed on Oct. 31, 2006, the disclosure of which is incorporated herein by reference.

### BACKGROUND

1. Field of the Disclosure

Embodiments of the present disclosure relate generally to digital media, and specifically to the dynamic supply of content and presentation in a digital magazine.

2. Description of the Related Art

Digital media is a combination of a number of intersecting ideas and technologies. In some ways, digital media is strongly correlative of typical “paper” media, such as newspapers, books, and magazines. E-books are perhaps one of the most well-known attempts to create digital media. E-books allow a reader to view the pages of a book in digital form on virtually any conventional computing device including a computer, laptop, PDA, and the like. E-books are generally more cost efficient to produce (no printing and less production costs), more environmentally friendly (no need for paper), and easily distributed (via disk or internet download, for example). However, users have been less receptive to e-books than at least some initial estimates because many people had a hard time getting used to the format, and at least, at the time, fewer people had devices capable of displaying the e-books that were as easily portable as the books themselves.

On another end of the digital media spectrum, there are websites and e-mails used to entertain, inform, or promote certain products. Many sites and e-mails have static articles, information, and/or pictures, while others provide some degree of interactivity.

Digital magazines are currently developing as a mechanism for merging traditional and online sources, particularly—although not exclusively—in the realm of advertising. Digital magazines are generally a collection of electronic pages containing text, graphics, links, and embedded media files, such as sounds, graphics or videos; these pages are linked together and can be digitally “turned” through animations that mimic the turning of an offline magazine. Despite the increasing presence of internet access and web sites, there are still some members of the public who are reluctant to turn to digital sources of information or are discouraged by the technology involved. To these internet-reluctant individuals, digital magazines offer the familiarity and ease of traditional magazines by offering a simple page-turning interface, while also offering interactivity and cost and distribution efficiencies of digital media. To internet-savvy individuals, digital magazines offer a more unique, simple interface and greater enjoyment of use than typical websites may be able to offer. Digital magazines are offered through technologies generally referred to as “flip pages.” Digital Magazines and flip pages are commercially available from companies such as NXTbook Media (http://www.nxtbookmedia.com).

### SUMMARY

Customization and individualization create a more unique and positive experience for a user. For example, a digital magazine that mimics an offline magazine (such as Sports Illustrated, Time, Newsweek, or People) may reopen to the last page a user viewed the last time that person accessed the magazine. In other instances, a digital magazine might arrange its articles or pages differently based on the user's own preferred topics. In an embodiment, the content itself may be customized for various users. For example, content including advertising may be tailored to individual users or groups of users viewing that content by accessing user-specific data. User-specific data may include, but is not limited to demographic data, name, e-mail, or other data entered by a user or gleaned from other sources, as well as, digital magazine pages viewed, items clicked, time spent viewing, number of times visited, and articles read. Demographic data may also be used to customize the digital magazine experience. Demographic data may also include data such as: a user's age, sex, race, area of residence, occupation, income, marital status, and any of a host of other data know to an artisan from the disclosure herein.

Moreover, the digital magazine may be distributed via email or mass email mailings to random, demographically-selected, or other pre-defined or pre-selected groups. In such broadcast or directed emails, the email may include a selectable link to a server capable of serving digital magazine content.

In an embodiment of this disclosure, an interactive, user-customized digital magazine incorporates user-specific tracked and/or demographic data that is used to provide an automatically customizing internet magazine experience. In an embodiment, the system tracks and stores such demographic or user-specific data and utilizes it to customize a digital magazine. Yet another embodiment of the disclosure is to provide a marketing, information, education, or entertainment experience that includes sending electronic mail to a customer, the email including a mechanism, such as a link, for accessing such a digital magazine. The digital magazine capable of aggregating data from one or more interactions with one or more users to supply valuable feedback to entities associated with the magazine, including for example, advertisers and the like.

### BRIEF DESCRIPTION OF THE DRAWINGS

A general architecture that implements the various features of the disclosure will now be described with reference to the drawings. The drawings and the associated descriptions are provided to illustrate embodiments of the disclosure and not to limit its scope. Throughout the drawings, corresponding reference numbers indicate corresponding parts and the initial digit of each number indicates the figure in which that element first appeared.

FIG. 1 illustrates an exemplary block diagram of a delivery mechanism for delivering a customizable digital magazine, according to an embodiment of the present disclosure.

FIG. 2 illustrates an exemplary block diagram of a server and access point of the delivery mechanism of FIG. 1, according to an embodiment of the present disclosure.

FIG. 3 illustrates an exemplary flow chart of a method for tracking consumer interactions with a digital magazine.

### DETAILED DESCRIPTION

To more readily understand this disclosure, it may be instructive to look at a few specific embodiments of the systems and Methods as contemplated by the present disclosure.

Automobile manufacturers, such as Ford, GM, and Daimler-Chrysler, spend tremendous resources developing large, glossy, full-color booklets that they provide to potential customers, either through the mail, auto shows, or when someone visits a dealership. While these brochures are helpful, the pictures and information are static and each brochure can be costly. In an embodiment of the present disclosure, a manufacturer may elect to send e-mails linking to or otherwise attaching electronic brochures. In the context of the automobile industry, these e-mails, for example, may be sent to customers who have come to test drive cars and have signed up for more information, may be previous customers already in a dealer's database, may have visited an autoshow, or may have otherwise been selected from other databases of email information. In an embodiment, Ford may utilize its customer database to send the previous purchasers of its Sport Utility Vehicles (SUVs) an electronic brochure about its upcoming redesigned models. To do this, Ford may determine what customers have purchased Ford SUVs between, for example, three and six years ago and send them an e-mail with a link to the electronic brochure. The brochure may display typical photos and text of a physical brochure and it may allow a user to interact with the photos and information to experience a wide variety of audio or visual presentations, including for example, video of the Explorer's on and off-road capabilities, customizations of the SUV's color, options, and pricing information, and any of a number of other options. In an embodiment, the e-mail link may customize the electronic brochure using user or group specific data that alters some or all of the electronic brochure.

For example, Driver 1, who currently drives a black Explorer, may receive an email linking to an electronic brochure full of pictures of new Explorers, with black Explorers dominant. At the same time, Driver 2, who drives a red Expedition, may receive an email linking to an electronic brochure with the red Expedition prominently displayed on the “cover” and as the first pages of the brochure.

In an embodiment, the electronic brochure can monitor the recipient's usage and send that information back to the server. This interaction data may be used to further customize the current brochure, update the brochure the next time it is opened, and/or be aggregated with other user interaction data to supply Ford with valuable information about the preferences of users having known demographics.

For example, although Driver 2 has been driving the Expedition, the electronic brochure might detect that she skipped those pages or spent much more time interacting with a “build an Escape Hybrid” feature. The electronic brochure stores this information temporarily, which it may or may not utilize during the present session. It may then send the information to one or more of the magazine server, other data acquisition servers, and/or Ford's servers. From this data, she may experience a page touting a special tax incentive on hybrid vehicles later in the brochure, the next opening of the brochure or the like.

In another example, a mobile phone manufacturer wishes to entice users to switch brands. Perhaps market research indicates that most young adult professionals prefer the company's thinnest, lightest model, while teenagers prefer a model that comes in a myriad of colors and provides text and picture messaging capabilities. The manufacturer then utilizes a potential customer database that it has amassed or has access to, and each potential customer receives an e-mail with a link to a digital magazine containing the manufacturer's phones. Each potential customer's link is coded with corresponding demographic data. Teenagers open the digital magazine to find the opening pages discuss a phone that has exchangeable faceplates and a camera. One page may also include a mock-up of such a phone that is interactive, allowing a user to simulate sending (or even actually send) text messages, interchange variously styled faceplates, view streaming entertainment or sports stories such as would be available as a service on that phone, and the like. Meanwhile a young doctor opens the brochure to find a comparison of three of the manufacturer's thinnest and lightest models, with the company's Blackberry® or other mobile e-mail capable devices next and the more teen-styled phones at the end of the brochure.

Similarly, this disclosure's systems and methods are not limited to advertising. Traditional, offline magazines may offer digital magazine versions. For example, Sports Illustrated (SI) may create a digital version of its magazine. Each week all SI subscribers may receive an email with a link to the digital magazine. The digital magazine may include not only the pictures and articles of the offline version, but also video interviews with players, animations on golf swing mechanics, interactive features, and the like. With the user-specific and demographic information stored in its database, the digital SI may have articles arranged with baseball first for one subscriber and basketball first for another. Advertisements may also act as links to the advertiser's sites, and SI may track the ad “click-throughs” to provide each subscriber with the most relevant or interesting ads. SI may, of course, also utilize this information when pitching advertising space to various potential advertisers.

Furthermore, catalogues may utilize this technology. Both digital magazines and catalogues may also include additional trackable and/or servable content that may otherwise be too cumbersome for a traditional offline magazine or catalogue. For example, many advertisements prominently feature a single product but include a number of others. One instance of this may include an advertisement for cereal featuring a family sitting around a kitchen table. Although the focus is on the cereal, each “family member” model has clothes from various manufacturers, kitchen appliances may be visible in the background, and the like. In an embodiment, a user may be able to mouse-over, click on, or otherwise select these “background” items to find more information about them. The various selections may be tracked and new advertisements more prominently featuring those products or their manufacturers may be included the next time the magazine is opened, additional electronic catalogues could be sent to the recipient, or the like. For instance, the kitchen scene described may provide information on the Kohler® appliances in the kitchen, may queue up Kohler®-specific advertisements elsewhere in the electronic magazine, place the user on a Kohler® electronic catalogue mailing list, or the like.

In addition, the system of the present disclosure may advantageously store records of a user's interactivity with the magazine, and compile many users interactivity in order to provide very relevant and important market feedback to the manufacturer. Such feedback may give manufacturers valuable information on, for example, preferred customization by certain market, geographic, and/or demographic segments or profiles. For example, the manufacturer may learn that teenagers of a certain demographic customize their phones in dark colors, prefer text messaging and high resolution pictures, as well as, for example, indications of their disposable income. Some or all of this interaction information may be gathered by monitoring the user's interaction with the magazine.

Systems and methods which represent various embodiments and example applications of the present disclosure will now be described with reference to the drawings.

Overview

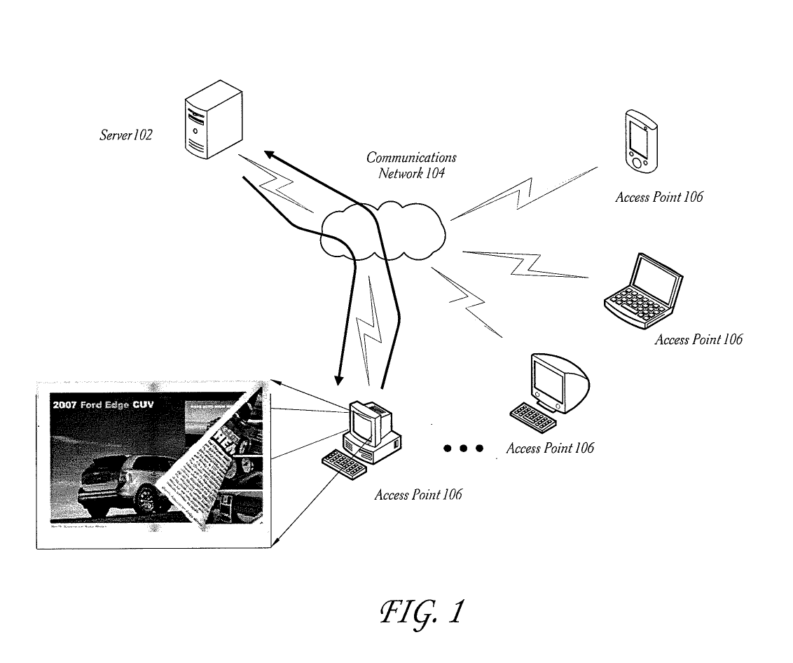

FIG. 1 illustrates an embodiment of an exemplary delivery mechanism including a digital magazine server 102 connected to any of a variety of access points 106 through a communications network 104, such as the internet. Access points 106 can be any of a wide variety of computing devices including personal computers, desktops, laptops, workstations, personal digital assistants (PDAs), cell phones, and the like. As stated, the communications network 104 comprises one or more communication mediums, the internet, any of a wide variety of public and private LANs, WANs, wired and/or wireless networks, combinations of the same, and the like. The digital magazine server 102 typically stores the digital magazine content and sends it to any one of the access points 106 when requested by a user at the access point.

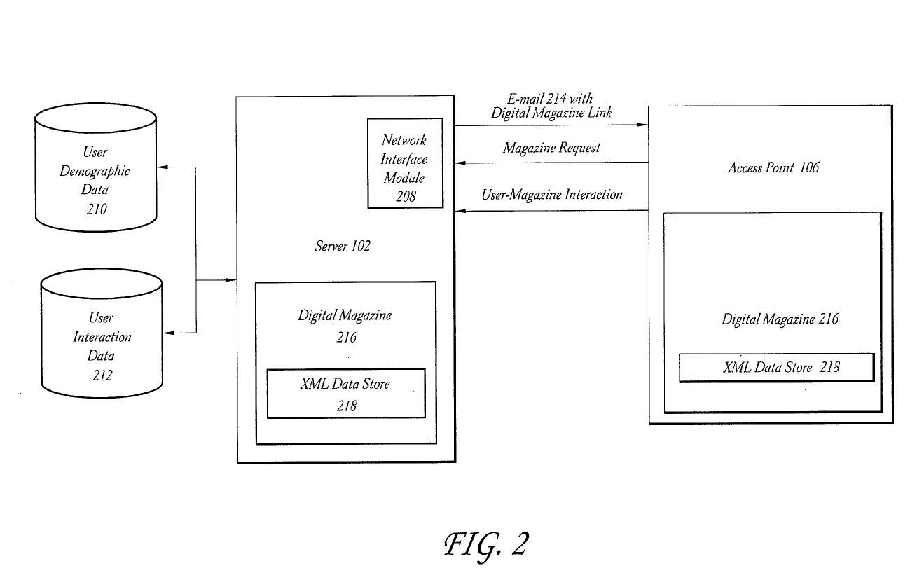

FIG. 2 shows a more detailed view of the modules involved in this system. The digital magazine server 102, in an embodiment, comprises a network interface module 208 and comprises or interacts with one or more databases storing user demographic data 210 and user interaction data 212. In an embodiment, the digital magazine server utilizes network interface module 208 to send out e-mails 214 that may contain user demographic data 210 and/or user interaction data 212. Each e-mail 214 preferably contains information about the recipient, such as name, address, survey information, demographic information, and the like. In an alternative embodiment, e-mail 214 may include a unique user ID that correlates to a larger data record in the digital magazine server 102's database(s). The digital magazine server 102 also utilizes network interface module 208 to send digital magazines 216 to users upon request. Digital magazines 216, in an embodiment, include machine readable instructions or files residing on a computer-readable storage medium and include a data store 218 which may be utilized to track user interactions and/or temporarily store information entered by a user.

Data store 218 is an XML file, in an embodiment, but may be any of a number of data records or files in various formats that are suitable for transfer over communications network 104. User interaction data 212 is updated with information recorded in data store 218 based on a user's interactions with the digital magazine allowing tracking of user interactions, and, in some embodiments, improved, rearranged, or special content during further interactions. In some embodiments, an entire digital magazine 216 may be provided to access point 106; in others, portions of digital magazine may be provided to access point at various times, such as on request or through streaming. The data store 218 may reside temporarily on the access point 106 in some embodiments. In others, such as when only portions of the digital magazine 216 are provided to access point 106 at any time, the data store 218 may reside on the server 102. It is also possible in such a case that data store 218 may be eliminated in favor of storing user interactions in the server 102 associated database(s), storing, and thereby updating, user interaction data 212. Some examples of data that may be stored with the data store 218 in various embodiments include: portions of a magazine selected, magazine links clicked, time spent on various pages, user input, such as, survey forms completed, and the like. The various components will be discussed in greater detail below.

Digital Magazine Server 102

As stated, in an embodiment, digital magazine server 102 comprises one or more databases, storing one or both of user demographic data 210 and user interaction data 212, and a network interface module 208. In an embodiment, digital magazine server 102 is a web server, capable of interacting with an access point's 106 web browser to provide the digital magazines. In an embodiment, digital magazine server 102 may also include an e-mail server, such as an SMTP, POP3, or IMAP server so as to send out e-mails 214.

Associated Database(s)

The server 102 user database(s) is/are capable of storing records on each individual who receives or accesses a particular digital magazine. Individual records can comprise a myriad of different information, including a name, a unique ID number, an address, e-mail address, other contact information, survey response information, demographic information, and magazine use information. Survey response information may include hobbies, interests, car preferences, and the like. Demographic information may include information supplied by a user or gathered from external sources and may include race, sex, age, income level, occupation, and the like. Magazine use information correlates to an individual's interaction with a given digital magazine, such as, for example, pages viewed, time spent on each page, links clicked, information entered on forms, and so on. Returning to the Ford brochure example, the database(s) might keep track of a driver's name, email, other contact information, the fact that she currently drives a red Expedition, and the time spent playing with the “build an Escape Hybrid” feature. This information may be used to customize her digital magazine during her next access, such as by adding the page explaining hybrid vehicle tax incentives.

The information contained in the records of the server 102's database(s) may be used to populate user data in e-mails 214. In an embodiment, it may also be used to pre-populate or update digital magazine 216's data store 218. Similarly, information recorded during a user's interactions with digital magazine 216 by data store 218 may update the user interaction data 212 in the digital magazine server's associated database(s).

The database or databases may reside on the same hardware and/or computer readable medium as the digital magazine server 102. In other embodiments, the database or databases may be physically separate but allow communication with the digital magazine server 102.

Network Interface Module

The digital magazine server 102 may include a network interface module 208 that communicates with the digital magazine server 102 to facilitate communication between the digital magazine server 102 and the access points 106 via the communications network(s) 104.

The network interface module may utilize a variety of network protocols. In one embodiment, the network interface module includes the Hypertext Transfer Protocol (HTTP). However, it is to be appreciated that other types of network communication protocols may be used, such as HTTPS, FTP, SMTP, and TCP/IP. In some embodiments, the network interface module may include or reside on hardware such as a modem, a network interface card, a wireless network card, and the like.

Input and Output Devices

The digital magazine server 102 may communicate with a set of input and output devices. For example, the input device(s) may include a keyboard, roller ball, pen and stylus, mouse, trackball, voice recognition system, or pre-designated switches or buttons. The input device(s) may also include a touch screen associated with an output device. Textual or graphic information may be entered by the user through the input device. The output device(s) may include a speaker, a display screen, a printer, or a voice synthesizer.

It is recognized that in some embodiments, one or more of the input and output devices may be included in the digital magazine server 102. For example, the digital magazine server 102 may include a built-in set of speakers and a built-in touchpad.

Digital Magazine Server System Information

The digital magazine server 102 may include a conventional general purpose single-chip or multi-chip, single-core or multi-core microprocessor such as a Pentium® processor, a Pentium® II processor, a Pentium® Pro processor, an xx86 processor, an 8051 processor, a MIPS® processor, a Power PC® processor, or an ALPHA® processor. In addition, the microprocessor may be any conventional special purpose microprocessor such as a digital signal processor. Furthermore, the digital magazine server 102 may be used in connection with various operating systems such as: Microsoft® Windows® 3.X, Microsoft® Windows 95, Microsoft® Windows 98, Microsoft® Windows® NT, Microsoft® XP, Microsoft® Windows® Vista, Microsoft® Windows® CE, Palm Pilot OS, OS/2, Apple® MacOS®, Apple® OS X™, Disk Operating System (DOS), UNIX, Linux®, VxWorks, or IBM® OS/2®, Sun OS, Solaris OS, IRIX OS operating systems, and so forth.

In one embodiment, the digital magazine server 102 is a tower server, a blade server, a personal computer, a laptop computer, a portable computing device, a computer workstation, a local area network of individual computers, an interactive kiosk, a personal digital assistant, an interactive wireless communications device, a handheld computer, an embedded computing device, or the like. It is important to note that the digital magazine server 102 may comprise one or multiple servers and be operated by the same or different entities. For example, the e-mail server functions may be on one physical machine operated by a first entity, while the digital magazine serving functions may be conducted on a different physical machine, either operated by the first entity or another entity.

As can be appreciated by one of ordinary skill in the art, the digital magazine server 102 may include various sub-routines, procedures, definitional statements, and macros. Modules discussed herein may be software stored on a suitable computer readable medium, typically separately compiled and linked into a single executable program. However, it is to be appreciated by one of ordinary skill in the art that the processes that are performed by selected ones of the modules may be arbitrarily redistributed to one of the other modules, combined together in a single module, made available in a shareable dynamic link library, or partitioned in any other logical way. Additionally, the network interface module, and/or the databases may be an “application program,” may reside as part of the operating system for the device, or may reside partly in both.

As used herein, the word module refers to logic embodied in hardware or firmware, or to a collection of software instructions, possibly having entry and exit points. Furthermore, the modules may be written in any programming language such as C, C++, BASIC, Pascal, Java, and FORTRAN compiled and linked into an executable program, installed in a dynamic link library, or may be written in an interpreted programming language such as BASIC, Perl, or Python. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware.

Access Point 106

In one embodiment, the access point 106 provides remote access to the information stored in the digital magazine server 102. In a preferred embodiment, the access point 106 is a personal computer comprising at least one each of input and output devices as well as a network interface module for communications with the digital magazine server 102. It is understood, however, that access point 106 and digital magazine server 102 may reside on the same physical machine, such as a PC. In such a case a network interface module may not be required as a single processor may perform the actions of both the access point 106 and the digital magazine server 102 and internal communications may be sufficient in such an embodiment.

In one embodiment, a user may utilize the access point 106 to electronically send and receive data from the digital magazine server 102, via a browser module. The access point 106 may send and receive data using one of any number of network protocols. In one embodiment of the disclosure, the request comprises a Hypertext Transfer Protocol (HTTP) request. However, it is to be appreciated that other types of network communication protocols may be used. In an embodiment, access point 106 may have access to an e-mail client. This e-mail client may be native or web-based, but the access point 106 preferably allows a user to retrieve e-mail 214.

Browser Module

In one embodiment, the user system(s) 106 include a browser module (not shown). The browser module may present the customized digital magazine to the user as a web page. The browser module and/or digital magazine accessible via the browser module may allow the user to request additional data, add data, delete data, and/or modify data.

The browser module may be implemented as a module that uses text, graphics, audio, video, and other media to present data and to allow interaction with the data via the communications medium. The browser module may be implemented as a combination of an all points addressable display such as a cathode-ray tube (CRT), a liquid crystal display (LCD), a plasma display, or other types and/or combinations of displays. In addition, the browser module may be implemented to communicate with input devices and may also include software with the appropriate interfaces which allow a user to access data through the use of stylized screen elements such as, for example, menus, windows, dialog boxes, toolbars, and controls (e.g., radio buttons, check boxes, sliding scales, etc.). Furthermore, the browser module communicates with a set of input and output devices to receive signals from the user. It is recognized that in other embodiments, the browser module may be implemented as a general interface that does not include access to the communications medium.

In other embodiments, a digital magazine may be presented as a stand-alone program that does not utilize a browser interface at all. In such an embodiment, the digital magazine may be a stand-alone application capable of creating and managing, through the operating system, its own window. The stand-alone application may itself be further capable of interacting with the network interface module (discussed below) for communication with the digital magazine server 102.

Network Interface Module

The access points 106 may also include network interface modules (not shown) to facilitate communication between the digital magazine server 102 and the access points 106 via the communications network 104. The network interface module may utilize a variety of network protocols. In one embodiment, the network interface module includes the Hypertext Transfer Protocol (HTTP). However, it is to be appreciated that other types of network communication protocols may be used. In particular, the access point 106's network interface module may be configured much like server 102's network interface module 208.

Input and Output Devices

In one embodiment, the access point 106 communicates with a set of input and output devices. For example, the input device(s) may include a keyboard, roller ball, pen and stylus, mouse, trackball, voice recognition system, or pre-designated switches or buttons. The input device(s) may also include a touch screen associated with an output device. Textual or graphic information may be entered by the user through the input device. The output device(s) may include a speaker, a display screen, a printer, or a voice synthesizer.

Access Point 106 Information

The access point 106 may include a conventional general purpose single-chip or multi-chip, single-core or multi-core microprocessor such as a Pentium® processor, a Pentium® II processor, a Pentium® Pro processor, an xx86 processor, an 8051 processor, a MIPS® processor, a Power PC® processor, or an ALPHA® processor. In addition, the microprocessor may be any conventional special purpose microprocessor such as a digital signal processor. Furthermore, the access points 106 may each be used in connection with various operating systems such as: Microsoft® Windows® 3.X, Microsoft® Windows 95, Microsoft® Windows 98, Microsoft® Windows® NT, Microsoft® XP, Microsoft® Windows® Vista, Microsoft® Windows® CE, Palm Pilot OS, OS/2, Apple® MacOS®, Apple® OS X™, Disk Operating System (DOS), UNIX, Linux®, VxWorks, or IBM® OS/2®, Sun OS, Solaris OS, IRIX OS operating systems, and so forth.

In one embodiment, the access point 106 is a personal computer, a laptop computer, a Blackberry® device, a portable computing device, a server, a computer workstation, a local area network of individual computers, an interactive kiosk, a personal digital assistant, an interactive wireless communications device, a handheld computer, an embedded computing device, or the like.

As can be appreciated by one of ordinary skill in the art, the dealer system may include various sub-routines, procedures, definitional statements, and macros. Each of the foregoing modules are typically separately compiled and linked into a single executable program. However, it is to be appreciated by one of ordinary skill in the art that the processes that are performed by selected ones of the modules may be arbitrarily redistributed to one of the other modules, combined together in a single module, made available in a shareable dynamic link library, or partitioned in any other logical way. For example, in one embodiment, the browser module and the network interface module are integrated into a single executable module. Furthermore, for example, in another embodiment, the browser module is maintained in a dynamic link library that is separate from the network interface module. In addition, the browser module and the network interface module may be either an “application program,” reside as part of the operating system for the device, or can reside partly in both.

Operation

Returning to FIG. 2, sample operations of the digital magazine server 102 will now be discussed. In an embodiment, digital magazine server 102 sends an email 214 to a user containing user data, which may be in the form of an individualized link to a digital magazine 216. In an embodiment, the user data will simply be a unique user ID corresponding to that user's record entry in the digital magazine server. In another embodiment, user data may be more extensive so as to bypass additional accessing of the server 102's user information database(s) when requesting the digital magazine 216. Upon clicking on the link or otherwise accessing the digital magazine, the access point 106 which the user is utilizing sends communications to the server 102 requesting the digital magazine 216.

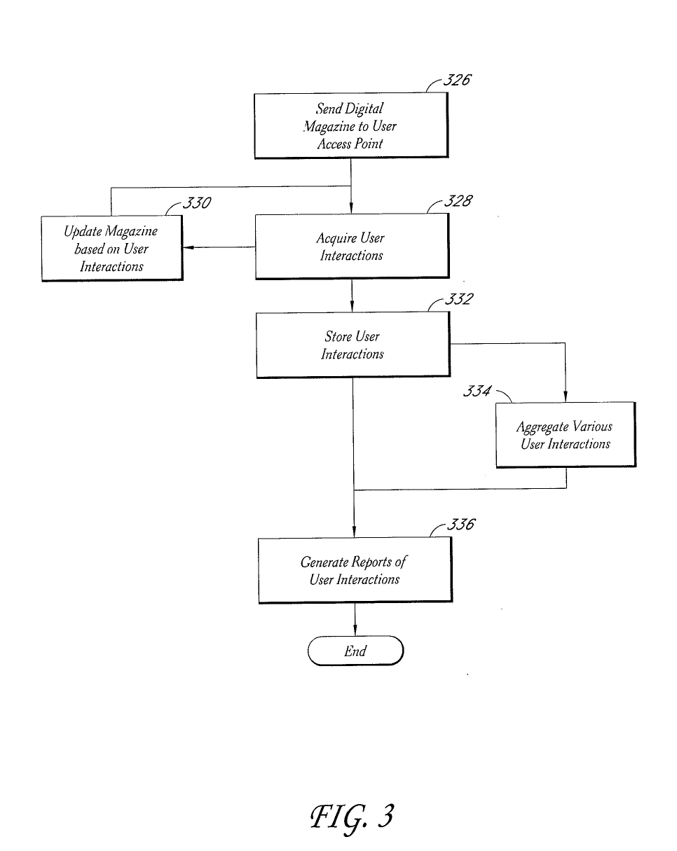

Turning to FIG. 3 more specifically, the digital magazine server 102 reads the individualized data sent from the access point 106 and returns the appropriate digital magazine 216 in block 326. Depending on the way a user accesses a digital magazine, in an embodiment, digital magazine server 102 may access the server database(s) to populate digital magazine 216's data store 218 with individualized data, such as user demographic data 210 and/or user interaction data 212. In other embodiments—like with respect to an e-mail 214 containing a link with more extensive user information—data store 218 may be populated with user specific information without retrieval from the digital magazine server's user database(s). Digital magazine 216 may be in the form of an applet or web page opened in a browser, may download as a stand alone application, or may download to a special purpose display application in various embodiments.

At this point, in an embodiment, the digital magazine 216—or a portion thereof—resides on the access point 106 and it continually or periodically monitors a user's interactions with it. Flipping pages, clicking on links, engaging interactive demonstrations, and the like may all be monitored and recorded in data store 218 (block 328). In an embodiment, specific user interactions may trigger the digital magazine 216 to update itself (block 330). For example, clicking on a certain link may trigger advertisements on that or other pages to change, change the ordering of digital magazine pages or the like. Additionally (or alternatively), in an embodiment, the user interactions may prompt the digital magazine 216 to request new or additional information from the server in order to complete an update.

The user interactions that are stored in data store 218 may also be returned to the digital magazine server 102 periodically and/or when a user closes out of the digital magazine 216 to update user interaction data 212 (block 332). This information can be utilized when the user accesses the digital magazine in the future, such as opening the magazine to the page on which the person left off, providing additional or varied content and the like. Furthermore, this new user interaction data 212 may be aggregated with the user interaction data 212 of other users (block 334) to generate reports (336) which may help the digital magazine provider to determine what articles were most popular, what advertisements were most important to certain people, and/or any of a number of other traits. Reports may also be generated on each individual user in at least one embodiment (blocks 332, 336).

Alternatives

While the digital magazine delivery has been described in terms of a server, an e-mail, and a digital magazine, other embodiments of the present disclosure will be known to those of skill in the art from the descriptions herein. For example, it is possible in an embodiment to bypass an e-mail altogether. Instead, a user may browse to a website where they can access the digital magazine. In such a case, the user may be required to log in to correlate the user with individualized data stored in the user database. Alternatively, the server may utilize a cookie stored on the user's computer or the user's internet protocol (IP) address as proxies for a log in or the e-mail's user data 310. Similarly, e-mail 214 may instead be a text message or voicemail sent to a user's mobile phone. In such a case, the mobile phone may act as the access point and a response to a voicemail or text message may prompt the server to send the digital magazine to the mobile phone for viewing on its screen.

Alternative embodiments may monitor user interactions with a loaded digital magazine continuously or periodically. Similarly other embodiments may stream or communicate user interactions back to digital magazine server and its associated databases continuously, at specific or random intervals, based on user triggers, and the like. In some embodiments, data store 218 may reside on server 102 to help limit the memory required on access point 106—this may be particularly useful when the access point 106 is a personal digital assistant, a mobile phone, a Blackberry® or similar device, and the like.

Although the foregoing has been described in terms of certain preferred embodiments, other embodiments will be apparent to those of ordinary skill in the art from the disclosure herein. Moreover, the described embodiments have been presented by way of example only, and are not intended to limit the scope of the disclosure. Indeed, the novel methods and systems described herein may be embodied in a variety of other forms without departing from the spirit thereof. Accordingly, other combinations, omissions, substitutions and modifications will be apparent to the skilled artisan in view of the disclosure herein. Thus, the present disclosure is not intended to be limited by the preferred embodiments, but is to be defined by reference to the appended claims. The accompanying claims and their equivalents are intended to cover forms or modifications as would fall within the scope and spirit of the disclosure.

What is claimed is:

1. A digital magazine server system configured to aggregate email recipient interactions with a digital magazine, the system comprising:
a recipient data store configured to store information including email addresses of a plurality of recipients of a broadcast email;
a server system configured to send digital magazine data to said recipients of said broadcast email, said magazine data capable of causing web browsers of the recipients to display a digital magazine customized for the recipients according to the information stored in the recipient data store, wherein the digital magazine includes interactive content from a content provider and interactive or passive advertisements, the server system also configured to receive interaction data from said web browsers of said recipients as said recipients interact with said digital magazine, said system configured to alter subsequently sent digital magazine data according to received interaction data and configured to aggregate said interaction data across many recipients to provide interaction trends to said content provider.

2. A customizable digital magazine server, comprising:
a recipient database capable of storing email recipient information; and
a digital magazine server capable of interacting with the recipient database and providing, to a device of an email recipient, a digital magazine customized based on email recipient information from the recipient database associated with the email recipient,
wherein the server is capable of receiving data indicative of the email recipient's interactions with the browser and aggregating said interaction data with other than that of other recipients to determine interaction trends.

3. The server of claim 2 wherein the digital magazine is capable of being displayed on at least one of a computer screen, a television, a personal digital assistant screen, and a mobile phone screen.

4. The server of claim 2 wherein the device includes a browser and the digital magazine is provided to the email recipient through the browser.

5. The server of claim 2 wherein the email recipient information includes demographic data.

6. The server of claim 2 wherein the interaction data includes data corresponding to responses to a survey provided by the recipient.

7. The server of claim 2 wherein the digital magazine server is capable of updating content of the digital magazine based on the recipient's interactions.

8. A method of providing a customized digital magazine, the steps of the method comprising:
receiving a request for a digital magazine triggered by a user selecting a link to the digital magazine in one of a website or an e-mail;
sending digital magazine content to the user, with the digital magazine content comprising a data store, the data store including user information;
receiving at least one indication of the user's interactions with the digital magazine;
updating aspects of the digital magazine content based on the at least one indication of a user's interactions; and
aggregating a plurality of user interactions to determine interaction trends.

9. The method of claim 8, wherein the user information includes at least one of individual data, demographic data, and digital magazine interaction data.

10. The method of claim 8, comprising providing at least some of the interactive trends to a customer.

11. The method of claim 8, comprising providing the aggregated user interactions to a customer.

12. The method of claim 8 wherein the data store is capable of storing the at least one indication of the user's interactions with the digital magazine for later return of the at least one indication.

13. A digital magazine stored on a computer readable medium, comprising:
instructions such that a pictorial representation of a magazine can be electronically displayed to a user based in part on a set of user-specific data;
further instructions allowing the digital magazine to track a user's interactions with the digital magazine,
wherein the digital magazine is further capable of communicating at least one indication of the user's interactions to a database that uses the at least one indication to update and store the set of user-specific data.

14. The digital magazine of claim 12 wherein the digital magazine is displayed on one of:
a computer screen;
a television;
a personal digital assistant screen; or
a mobile phone screen.

15. The digital magazine of claim 13 wherein the user-specific data includes demographic data.

16. The digital magazine of claim 13 wherein the instructions are executed within a web browser.

17. The digital magazine of claim 13 wherein the instructions are executed as a stand alone program.

18. The digital magazine of claim 13 wherein the user-specific data includes data indicative of the user's interactions with at least some content of the digital magazine.

19. The digital magazine of claim 13 wherein the user-specific data includes data corresponding to responses to a survey provided by the user.
